(19) United States
(12) Patent Application Publication
(10) Pub. No.: US 2017/0231427 A1
(43) Pub. Date: Aug. 17, 2017

(54) Toolbox Grill Assembly

(71) Applicant: Curtis Cathey, Manchaca, TX (US)

(72) Inventor: Curtis Cathey, Manchaca, TX (US)

(21) Appl. No.: 15/425,957

(22) Filed: Feb. 6, 2017

Related U.S. Application Data
(60) Provisional application No. 62/295,431, filed on Feb. 15, 2016.

(51) Int. Cl. A47J 37/07

(52) U.S. Cl. CPC A47J 37/0763; A47J 37/0704; A47J 37/0786

(57) ABSTRACT

In some embodiments, a barbecue grill assembly may include a barbecue grill and a telescoping arm including a coupling mechanism configured to couple to a trailer hitch assembly of a vehicle. The barbecue grill assembly may further include a bearing mechanism including a first portion coupled to the telescoping arm and including a second portion coupled to a bottom surface of the barbecue grill. The bearing mechanism may be configured to selectively rotate the barbecue grill about a pivot axis. In some embodiments, the barbecue grill assembly may include a housing that may be configured to disguise the barbecue grill as a tool box.

### CROSS-REFERENCE TO RELATED APPLICATION(S)

This application is a non-provisional of and claims priority to U.S. Provisional Patent Application 62/295,431 filed on Feb. 15, 2016 and entitled “Toolbox Grill Assembly,” which is incorporated herein by reference in its entirety.

### FIELD

The present disclosure is generally related to portable grills for food preparation, and more particularly to portable grills configured to mount to a trailer hitch assembly of a vehicle.

### BACKGROUND

Portable grills can be carried to a sporting event for tailgating or to a campsite for preparing food. However, portable charcoal grills and small gas grills typically provide limited cooking area and can be stolen.

### SUMMARY

In some embodiments, a barbecue grill assembly may include a barbecue grill and a telescoping arm including a coupling mechanism configured to couple to a trailer hitch assembly of a vehicle. The barbecue grill assembly may further include a bearing mechanism including a first portion coupled to the telescoping arm and including a second portion coupled to a bottom surface of the barbecue grill. The bearing mechanism may be configured to selectively rotate the barbecue grill about a pivot axis. In some embodiments, the barbecue grill assembly may include a housing that may be configured to disguise the barbecue grill as a tool box.

In some embodiments, a barbecue grill assembly may include a barbecue grill and a telescoping arm including a coupling mechanism configured to couple to a trailer hitch assembly of a vehicle. The barbecue grill assembly may further include a bearing mechanism including a first portion coupled to the telescoping arm and including a second portion coupled to a bottom surface of the barbecue grill. The bearing mechanism may be configured to selectively rotate the barbecue grill about a pivot axis.

In other embodiments, a barbecue grill assembly may include a barbecue grill and a mounting assembly configured to couple the barbecue grill to a trailer hitch assembly of a vehicle. The mounting assembly may include a telescoping arm including a hinged section configured to pivot about a hinge axis extending perpendicular to a length of the telescoping arm and including a hitch element coupled to a first end of the telescoping arm and configured to releasably attach to a trailer hitch of a vehicle. The mounting assembly may further include a bearing element including a first portion coupled to the telescoping arm and including a second portion coupled to a bottom surface of the barbecue grill.

In still other embodiments, a barbecue grill assembly may include a housing formed from a sheet metal material and configured to resemble a toolbox and a mounting assembly. The mounting assembly may include a bearing element including a first portion coupled to the housing and including a second portion. The first portion may be configured to pivot relative to the second portion about a pivot axis. The mounting assembly may further include a hitch element configured to couple to a trailer hitch of a vehicle. Additionally, the mounting assembly may include a telescoping arm having a first end coupled to the second portion of the bearing element and having a second end coupled to the hitch element. The telescoping arm may include at least one section having a hinge configured to pivot about a hinge axis parallel to the pivot axis, where the hinge axis and the pivot axis extend substantially vertically and perpendicular to a longitudinal axis of the telescoping arm.

### BRIEF DESCRIPTION OF THE DRAWINGS

FIGS. 1A-1D depict a barbecue grill mounted to a trailer hitch assembly of a vehicle, in accordance with certain embodiments of the present disclosure.

FIG. 2A depicts a cross-sectional view of a barbecue grill mounting assembly configured to couple to a trailer hitch assembly, in accordance with certain embodiments of the present disclosure.

FIG. 2B depicts a top view of the barbecue grill mounting assembly of FIG. 2A, in accordance with certain embodiments of the present disclosure.

FIGS. 3A-3B illustrate top views of a barbecue grill and a mounting assembly, in accordance with certain embodiments of the present disclosure.

FIG. 4A depicts a side view of the barbecue grill with a top cover in an open position, in accordance with certain embodiments of the present disclosure.

FIG. 4B depicts a perspective view of the barbecue grill of FIG. 4A, in accordance with certain embodiments of the present disclosure.

FIG. 4C depicts a top view of the barbecue grill of FIG. 4A, in accordance with certain embodiments of the present disclosure.

FIG. 5 depicts a block diagram of a barbecue grill, in accordance with certain embodiments of the present disclosure.

FIG. 6 depicts a block diagram of a barbecue grill including an internal heat-insulating housing, in accordance with certain embodiments of the present disclosure.

FIGS. 7A and 7B depict block diagrams of a portion of a barbecue grill including an insulated box, in accordance with certain embodiments of the present disclosure.

FIG. 8 depicts a flow diagram of a method of selectively adjusting a relative position and orientation of a barbecue grill, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In some embodiments, a barbecue grill assembly may include a housing formed from a metal material, such as a diamond-pattern metal, that may be configured to resemble a toolbox. The grill assembly may include a closable lid with a lock. The grill assembly can be mounted within the bed of a truck, onto a hitch of a vehicle, or onto another mounting structure. In some embodiments, the grill assembly may include a collapsible trolley that may be coupled to a bottom of the housing and that may be configured to raise and lower the grill assembly. Further, in some embodiments, the collapsible trolley may include wheels to allow for movement of the assembly.

In certain embodiments, the barbecue grill assembly may include a hitch mounting assembly including an attachment mechanism configured to couple to a trailer hitch assembly of a vehicle. The attachment mechanism may include a telescoping arm having a trailer hitch end and a barbecue grill end. The telescoping arm may be configured to extend and retract and can be coupled to a bottom of a barbecue grill. The telescoping arm may include or may be coupled to at least one segment including a hinge portion adjacent to the hitch trailer end. The hinge portion may be configured pivot about an axis to adjust a radial position of the barbecue grill relative to the trailer hitch assembly of the vehicle.

In some embodiments, the coupling mechanism between the bottom of the barbecue grill and the telescoping arm may include a bearing element or rotatable element. Further, the barbecue grill may be pivoted about an axis of the rotatable element to adjust a rotational orientation of the barbecue grill relative to the telescoping arm.

In some embodiments, the barbecue grill may include a cooking surface positioned above one or more burner assemblies. The burner assemblies may be confined within a container that may be insulated to isolate other components of the barbecue grill from the heat. The barbecue grill may further include one or more control elements, which may be positioned adjacent to the cooking surface. In certain embodiments, the control elements (such as knobs, buttons, switches, other user-selectable elements, or any combination thereof) may be positioned below a level of the cooking surface. In some embodiments, the control elements may include a touchscreen interface. In other embodiments, the control elements may include a Universal Serial Bus (USB) port configured to couple to a USB cable, which may be coupled to a computing device, such as smart phone, from which one or more components of the barbecue grill and the associated mounting assembly may be controlled.

In certain embodiments, the barbecue grill assembly may include one or more batteries, a control circuit, and a telescoping assembly actuator, which may be configured to adjust the telescoping arm. By interacting with one or more control elements, a user may cause the telescoping assembly actuator to selectively extend or retract the telescoping arm to adjust a distance between the barbecue grill and the trailer hitch assembly of an automobile. In other embodiments, the telescoping assembly actuator may include a crank, a winch, or other manually-controllable element accessible to manually extend the telescoping arm. Other embodiments are also possible.

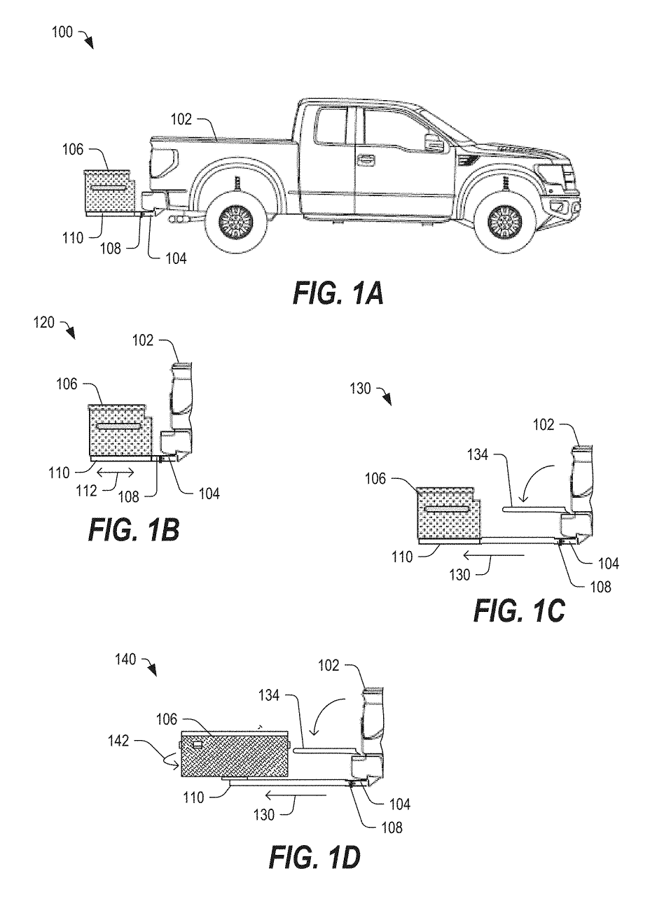

In the following discussion, various examples of a barbecue grill assembly are described below that may be coupled to a vehicle. One possible example of a barbecue grill assembly is described below with respect to FIGS. 1A-1D.

FIG. 1A depicts a system 100 including an automobile (such as a pickup truck 102) with a trailer hitch assembly 104, which may be coupled to a barbecue grill 106. The barbecue grill 106 may be coupled to a telescoping arm 110 (in a retracted position), which may be coupled to the trailer hitch assembly 104 by a coupling mechanism 108. In certain embodiments, the coupling mechanism 108 may include a coupler configured to grip a hitch ball by means of a latching mechanism, such as a handle assembly configured to position an “underjaw” component against the ball hitch of the trailer hitch assembly 104. In certain embodiments, the coupling mechanism 108 may include a coupling arm configured to engage a receiver portion of the trailer hitch assembly 104.

In the illustrated embodiment, the barbecue grill 106 may include a housing formed from a stamped metal material or may otherwise be made to resemble a toolbox. In an example, a diamond pattern sheet metal may be used to form one or more exterior surfaces of the barbecue grill 106. Further, latches may be provided to secure the lid, and one or more of the latches may include a locking mechanism configured to secure the barbecue grill 106 in a closed state. The locking mechanism may include the latches as well as a key/lock feature to prevent unauthorized access.

With respect to FIG. 1B, a system 120 includes the barbecue grill 106 coupled to the trailer hitch assembly 104 associated with a portion of the pickup truck 102. The telescoping arm 110 coupled to the barbecue grill 106 may extend or retract, moving the barbecue grill away from or toward the trailer hitch assembly 104, as generally indicated by the arrow 112.

In FIG. 1C, the system 130 is shown with the telescoping arm 110 in an extended (telescoped) position, which positions the barbecue grill 106 away from the portion of the pickup truck 102 in a direction generally indicated by the arrow 130. In certain embodiments, the barbecue grill 106 may be moved far enough from the trailer hitch assembly 104 to allow the tailgate 134 of the pickup truck 102 to be lowered while the barbecue grill 106 is being used. The lowered tailgate 134 may be used as a staging area or table, while the user is grilling the food.

In FIG. 1D, the system 140 includes the barbecue grill 106 coupled to the trailer hitch assembly 104 of the pickup truck 102. The telescoping arm 110 is extended in a direction of the arrow 130, and may be coupled to the barbecue grill 106 by a bearing assembly (or bearing mechanism) including a stationary plate coupled to the telescoping arm 110 and a second plate coupled to a bottom of the barbecue grill 106. In some embodiments, the second plate of the bearing assembly may pivot relative to the stationary plate to turn the barbecue grill 106 about an axis (as indicated by the arrow 142). By extending the telescoping arm 110 and by pivoting the barbecue grill 106 as indicated by arrow 142, the tailgate 134 may be extended (as shown). In certain embodiments, the telescoping arm 110 may include a hinge element near the coupling mechanism 108 to radially adjust a position of the barbecue grill 106 relative to the hinge assembly 104.

In certain embodiments, by extending the telescoping arm 110, pivoting the hinge element, and pivoting the barbecue grill 106 about a pivot axis, the barbecue grill 106 may be moved to one side of the rear of the pickup truck 102 and turned to facilitate use. The tailgate 134 may then be lowered and can be used as a staging area or as a table.

In some embodiments, the barbecue grill 106 may be coupled to the trailer hitch assembly 104 of the pickup truck 102. The telescoping arm 110 may be maintained in a retracted position during transport. During use, the barbecue grill 106 may be used in the retracted position or may be repositioned using the telescoping arm 110, the hinge element 108, and the bearing assembly. Other embodiments are also possible.

Depending on the implementation, the barbecue grill assembly 106 may include a fuel source, such as a propane tank. In other embodiments, the propane tank may be external to the assembly 106 and may be coupled to the assembly 106 during use. Other embodiments are also possible.

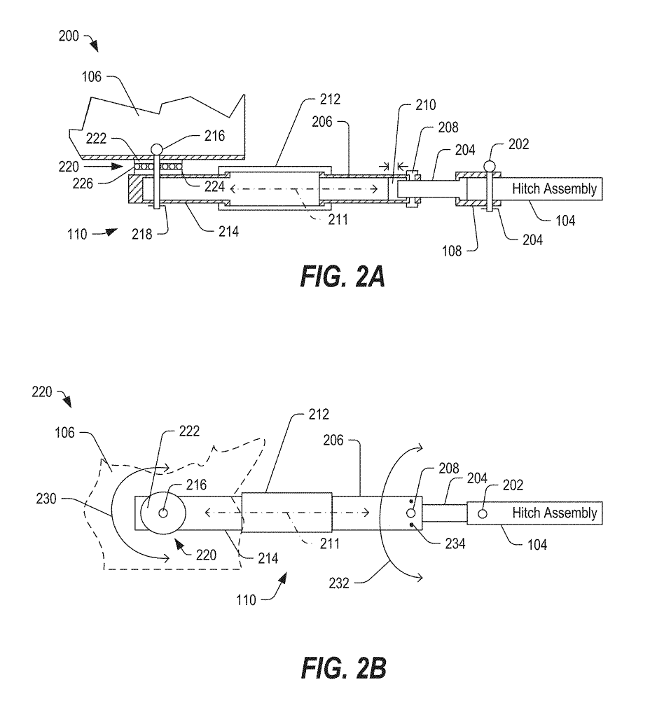

FIG. 2A depicts a cross-sectional view of a barbecue grill mounting assembly 200 configured to couple to a trailer hitch assembly 104 with the telescoping arm 110 in an extended state, in accordance with certain embodiments of the present disclosure. The telescoping arm 110 can include a coupling mechanism 108 defining an enclosure sized to receive a portion of the hitch assembly 104. The coupling mechanism 108 may be coupled to the hitch assembly 104 by a coupling pin 202, which may include a key 204 to prevent the coupling pin 202 from falling out. Further, the telescoping arm 110 may include a hinged component including a member 204 extending from the coupling mechanism 108 and coupled to an adjustable member 206 by a pin 208, which may form a hinge. The adjustable member 206 may include an opening 210 adjacent to the pin 208 and the end of the member 204 sized to allow the telescoping arm 110 to pivot about the pin 208 without contacting the end of the member 204. By pivoting the adjustable member 206, the barbecue grill 106 (only a portion of which is shown) can be moved along an arcuate path (generally depicted by arrow 232 in FIG. 2B) within a plane that is substantially parallel to the ground. The pin 208 may define a hinge axis that extends perpendicular to a longitudinal axis 211 of the telescoping arm 110. Further, the hinge axis may extend substantially perpendicular to the ground, and the longitudinal axis 211 may extend substantially parallel to the ground.

The telescoping arm 110 may further include one or more telescoping segments 212 coupled between the adjustable member 206 and a grill coupling member 214. The grill coupling member 214 may be coupled to a bearing element 220. The bearing element 220 may be coupled to the grill coupling member 214 via a releasable pin 216, which may be secured by a cotter pin 218 below the grill coupling member 214 and which may provide a pivot axis about which the barbecue grill 106 may be rotated relative to the telescoping arm 110. In certain embodiments, the cotter pin 218 may be removed and the releasable pin 216 may be pulled out of the opening through which it extends in order to decouple the barbecue grill 106 from the bearing element 220 and the telescoping arm 110. The bearing element 220 may include a first plate 222 configured to contact a bottom of the barbecue grill 106, a second plate 224 configured to contact a surface of the grill coupling member 214, and bearings 226 between the first plate 222 and the second plate 224.

In certain embodiments, the grill coupling member 214 may be coupled to the barbecue grill 106 via a bearing mechanism 220. The bearing mechanism 220 may include a first portion (e.g., a first metal plate) 222 coupled to the barbecue grill 106 and a second portion (e.g., a second metal plate) 224 coupled to the grill coupling member 214. The bearing mechanism 220 may include bearings or a sliding surface configured to allow the first portion 222 to pivot about a pivot axis relative to the second portion 224 and relative to the grill coupling member 214. In some embodiments, the pivot axis may be formed by and defined by a releasable pin 216, which may include a key or pin 218 that may be inserted through one end to hold the pin 216 in place.

FIG. 2B depicts a top view 220 of the barbecue grill mounting assembly 200 of FIG. 2A with the grill 106 depicted in phantom, in accordance with certain embodiments of the present disclosure. In the illustrated example, a portion of the barbecue grill 106 is shown in situ attached to the first portion 222 of the bearing mechanism 220, which includes the axis defined by the releasable pin 216. The adjustable orientation of the barbecue grill 106 is indicated by the arrow 230. Additionally, the radial movement allowed by the hinge 208 is generally indicated by the arrow 232, which represents the radial adjustment applied to the telescoping arm 110 made possible by the hinge 208.

In certain embodiments, the hinge element 206 may include a locking feature 234 configured to lock the telescoping arm 110 in a selected radial position. In some embodiments, the locking feature 234 may include an opening that can be aligned with a corresponding opening of the member 204 and through which a locking pin may be inserted. Other embodiments are also possible.

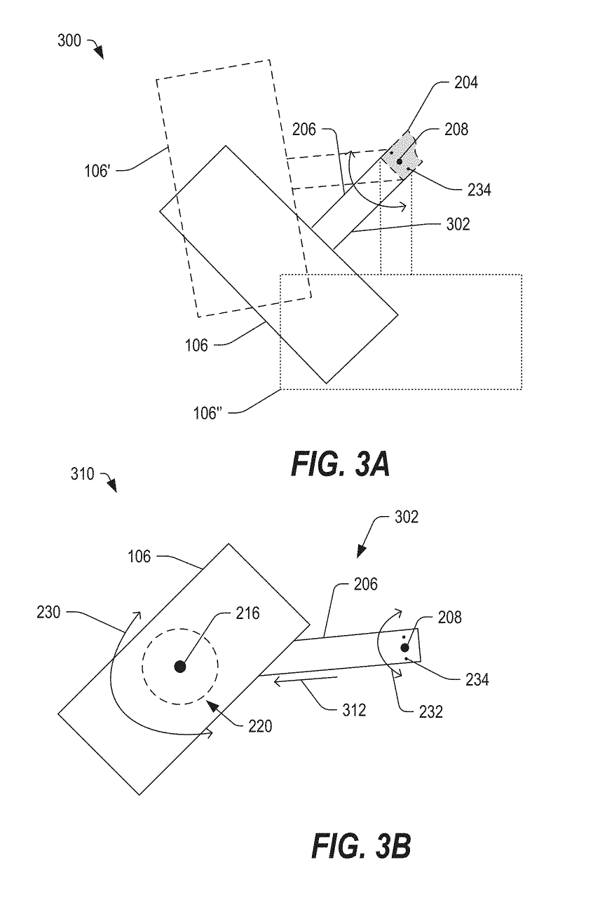

FIGS. 3A-3B illustrate top views of a barbecue grill and a mounting assembly depicting rotational features of the telescoping arm 302 and the grill 106, in accordance with certain embodiments of the present disclosure. In the illustrated examples, the telescoping arm 302 is an embodiment of the telescoping arm 110 in FIGS. 1A-2B.

In FIG. 3A, the barbecue grill 106 is coupled to the hinge element 208 by a telescoping arm 302. The telescoping arm 302 may be an example of the telescoping arm 110 in FIG. 1. In the illustrated example, the radial position of the telescoping arm 302 is depicted in three positions including a first position indicated by the grill 106, a second position indicated by the grill 106′, and a third position indicated by the grill 106″. The telescoping arm 302 may be pivoted relative to the member 204 about the hinge 208 of the hinge portion 206 to adjust the radial position of the telescoping arm 302 (and by extension the barbecue grill 106) relative to a trailer hitch to which the hinge portion 206 may be attached. Further, the barbecue grill 106 may be rotated relative to the telescoping arm 302 as indicated in FIG. 3B.

In FIG. 3B, a view 310 of the barbecue grill 106 is shown, with the grill 106 coupled to the telescoping arm 302 by a bearing element 220, which is configured to enable rotation of the barbecue grill 106 about an attachment axis formed by the releasable pin 216. The rotational capability is generally indicated by the arrow 230. The bearing element 220 allows the barbecue grill 106 to pivot about the releasable pin 216 relative to a longitudinal axis of the telescoping arm 302.

In the example of FIG. 3B, the mounting assembly includes the hinge portion 206, which may pivot about the hinge 208, and the bearing element 220, which may be used to pivot the barbecue grill 106 about the axis formed by the releasable pin 216. In certain embodiments, the telescoping arm 302 may be extended in a direction indicated by the arrow 312 to extend the barbecue grill 106 away from a rear of a vehicle, and then the telescoping arm 302 may be adjusted radially about the hinge 208 to adjust a position of the barbecue grill 106 to one side or the other of the trailer hitch. In other instances, the telescoping arm 302 may be retracted in a direction opposite to the arrow 312. Further, the barbecue grill 106 may be rotated about the axis formed by the releasable pin 216 to allow the barbecue grill 106 to be turned 90 degrees so that the length of the barbecue grill 106 is aligned with the length of the telescoping arm 302. Other embodiments are also possible.

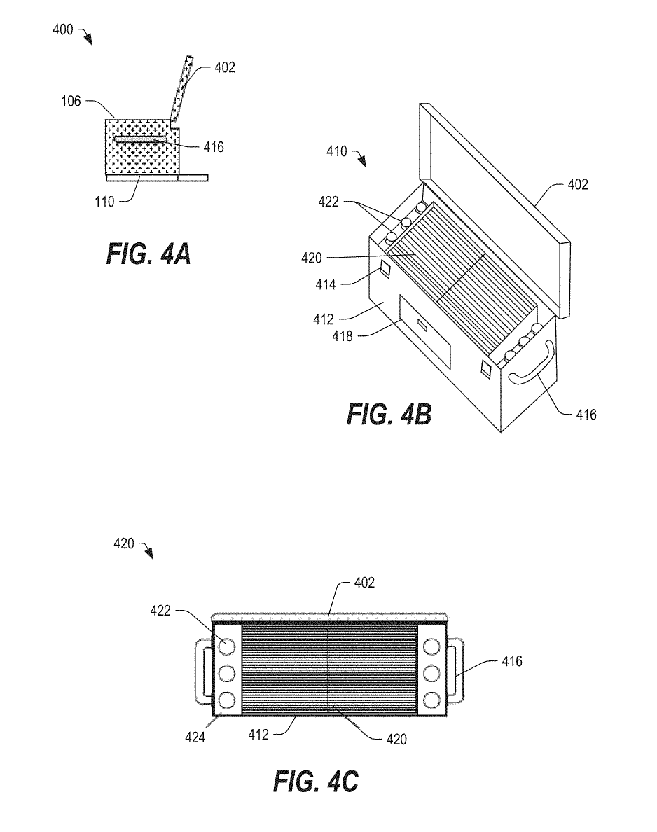

FIG. 4A depicts a side view 400 of the barbecue grill 106 with a top cover 402 in an open position, in accordance with certain embodiments of the present disclosure. The barbecue grill 106 may be one possible implementation of the barbecue grill 106 depicted in FIGS. 1-3B. As shown, the barbecue grill 106 may be coupled to the telescoping arm 110 (or 302 in FIG. 3). In the illustrated example, the barbecue grill 106 may include an exterior surface that includes diamond-patterned sheet metal and may be designed to resemble a toolbox. Further, the barbecue grill 106 may include a lid 402 that may be coupled to a hinge and configured to pivot into an open position about the hinge. Further, the barbecue grill 106 may include handles 416 along one or more sidewalls of the barbecue grill 106 to facilitate positioning.

FIG. 4B depicts a perspective view 410 of the barbecue grill 106 of FIG. 4A, in accordance with certain embodiments of the present disclosure. The lid 402 is in an open position, and may include closure mechanisms (not shown) configured to engage latches 414 along a front face 412 of the barbecue grill 106. In some embodiments, the barbecue grill 106 may include one or more drawers 418 accessible by a user to store grilling tools, such as scrapers, tongs, spatulas, and other items. In certain embodiments, the drawer 418 may be removed to allow access to components within the barbecue grill 106, such as batteries, burner assemblies, and the like.

From the perspective view 410, it should be apparent that the grill 420 can be positioned in a center portion of the barbecue grill 106, and may be raised relative to control elements 422 disposed along the edges. In certain embodiments, by positioning the control elements 422 (e.g., knobs, buttons, switches, and the like) below a level of the cooking surfaces of the grill 420, the control elements 422 may be isolated from flames and heating, allowing the user to control a gas flame (for example) without fear of being burned from a grease flare. Other embodiments are also possible.

FIG. 4C depicts a top view 420 of the barbecue grill of FIG. 4A, in accordance with certain embodiments of the present disclosure. From the top view, it can be seen that the grill 420 may be approximately centered within a housing of the barbecue grill 106. The control elements 422 may be located within a recessed control area 424 along lateral edges of the barbecue grill 106. In some embodiments, the barbecue grill 106 may include six burners, each of which may be independently controlled using the control elements 422.

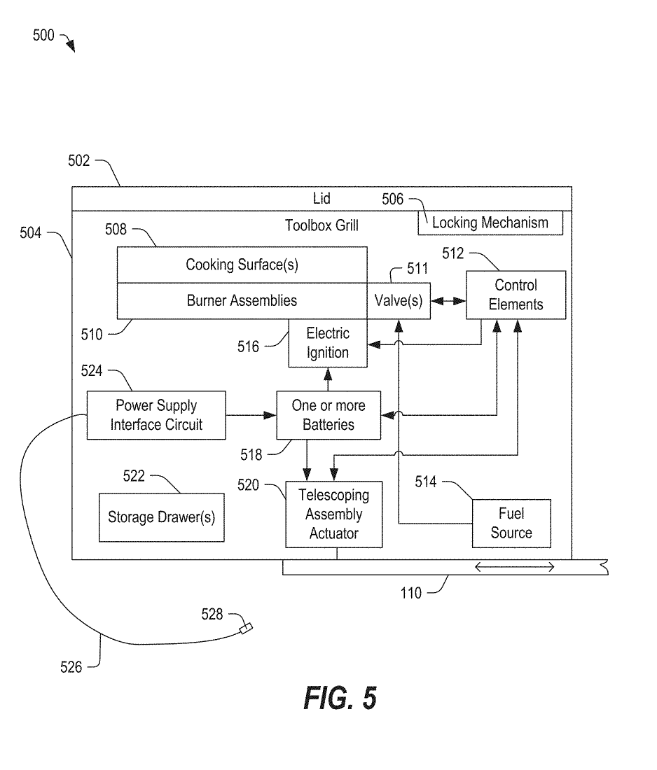

FIG. 5 depicts a block diagram of a barbecue grill 500, in accordance with certain embodiments of the present disclosure. The barbecue grill 500 may be an example of the barbecue grill 106 in FIGS. 1-4C. The barbecue grill 500 may include a housing 504 with a lid 502. The housing 504 may further include a locking mechanism 506 configured to selectively interface with the lid 502 to secure the lid 502 in a closed position. Further, the housing 504 defines an enclosure sized to secure a plurality of components, including one or more cooking surfaces 508, such as grills, grates, frying surfaces and the like. Further, the housing 504 may include burner assemblies 510 positioned beneath the cooking surfaces 508. In certain embodiments, the burner assemblies 510 may be configured to control the flow of a flammable gas, such as propane, from a fuel source 514, which may be housed within the barbecue grill 500 or which may be coupled to the burner assemblies 510 via one or more valves 511. The fuel source 514 may include a tank, such as a propane tank. In certain embodiments, the burner assemblies 510 may be positioned within a heating chamber, which may be isolated from the circuitry and other components of the barbecue grill 500.

The barbecue grill 500 may include an electric ignition component 516 coupled to the burner assemblies 510 and accessible via one or more control elements 512 to ignite a gas delivered through valves 511 and controlled using the one or more control elements 512. The control elements 512 may include knobs, switches, buttons, or other user-selectable elements accessible by a user to control valves 511 to adjust gas flow to the burner assemblies 510, to control the electric ignition to ignite the gas flow, to control an actuator, and so on. In some embodiments, the barbecue grill 500 may include one or more batteries 518 coupled to the electric ignition 516 and to one or more of the control elements 512. Further, the one or more batteries 518 may be coupled to a telescoping actuator assembly 520, which may include a motor and one or more actuators for selectively extending and retracting the telescoping arm 110.

In certain embodiments, the barbecue grill 500 may include a power supply interface circuit 524, which may include one or more wires for coupling to a power source, such as a wall outlet, a car battery, a tail-light connector for a trailer hitch attachment, a solar panel, and so on. Further, the power supply interface circuit 524 may be coupled to the one or more batteries 518 to provide power for recharge. In certain embodiments, the barbecue grill 500 may also include one or more storage drawers 522, which can be used to store grill accessories, such as scrapers, spatulas, tongs, cleaners, other items, or any combination thereof.

In the embodiments described above with respect to FIGS. 1-5, a barbecue grill may be disguised as a toolbox, by incorporating the form factor of a toolbox and by housing grill components within the form factor. Further, in some embodiments, the outer layer of the barbecue grill may be formed from a patterned sheet metal, such as a diamond pattern or another pattern that is common to truck-mounted tool boxes. In some embodiments, the housing may be formed from stainless steel.

Further, in some embodiments, the barbecue grill may include an inner heating assembly including sidewalls configured to direct heat away from circuitry and other components within the housing. Exterior walls may provide a cavity between the sidewalls of the inner heating assembly, which may be insulated, and the exterior walls. The cavity may be sized to receive circuitry, control elements, and other components that may need to be isolated from the heat of the burner assemblies. In certain embodiments, since heat rises, a majority of the components may be positioned at a level that is below a level of the burner assembly, and components that are above the burner assembly may be separated from the path of the rising heat by interior sidewalls or other spacing elements. Other embodiments are also possible.

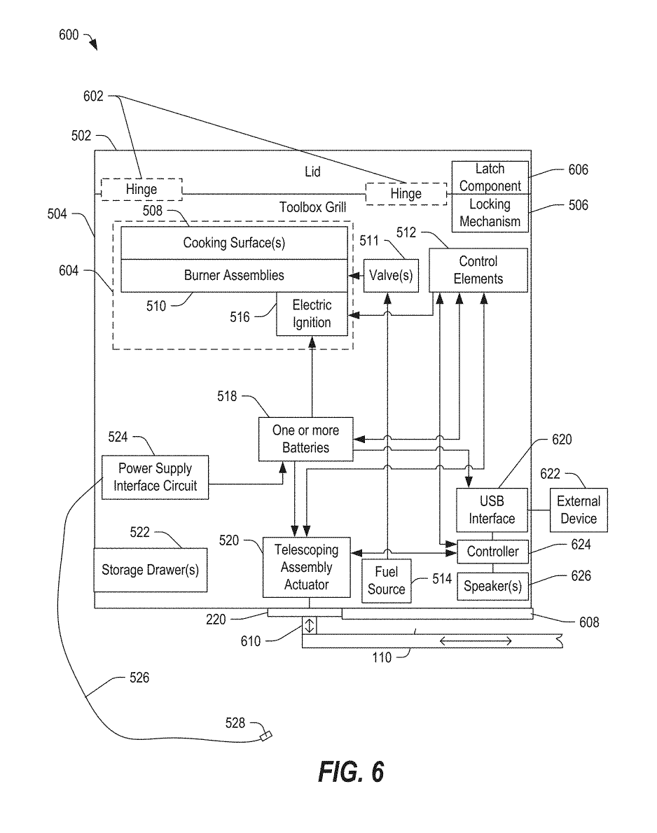

FIG. 6 depicts a block diagram of a barbecue grill 600 including an internal heat-insulating housing 604, in accordance with certain embodiments of the present disclosure. The barbecue grill 600 may include all of the elements of the barbecue grill 500 of FIG. 5, and may also include the heat-insulating housing 604 within the housing 504. In the illustrated example, the burner assemblies 510 and the electric ignition 516 may be included within the heat-insulating housing 604, and the cooking surfaces 508 may be positioned on top of and at least partially within the heat-insulating housing 604. In some embodiments, the heat-insulating housing 604 may include sides configured to surround the burner assemblies 510, the electric ignition 516, and the cooking surfaces 508; may include a bottom portion configured to define an insulated enclosure; and may be open along a top portion to allow heat to escape through and around the cooking surfaces 508. In certain embodiments, the heat-insulating housing 604 may be formed from stainless steel or another heat-resistive material. Further the sides and bottom of the heat-insulating housing 604 may be coated with an insulative material to prevent heat dissipation into the housing 504. The heat-insulating housing 604 is configured to operate as a heat shield to divert heat upward and away from other components, such as the control elements 5112, the batteries 518, the power supply interface circuitry 524, the telescoping assembly actuator 520, the fuel source 514, and the locking mechanism 506.

In the illustrated example, the locking mechanism 506 may include a latch or opening feature configured to selectively engage a latch component 606 within the lid 502. The locking mechanism 506 may be configured to engage the latch component 606 to secure the lid 502 in a closed position. Further, the locking mechanism 506 may secure the storage drawers 522. In some embodiments, the locking mechanism 506 may include a lock and associated key (not shown).

In the illustrated embodiments, the telescoping arm 110 may be coupled to the bearing element 220, which may secure the telescoping arm 110 to the housing 504. The telescoping arm 110 may be partially secured within guide rails 608 in a retracted position, and may be lowered below the guide rails 608 during an extension process using, for example, a vertical telescoping component 610. In some embodiments, the vertical telescoping component 610 may extend and retract along a substantially vertical axis to displace the telescoping arm 110 vertically and away from the guide rails 608, which may allow the grill 504 to be pivoted about an axis associated with the bearing element 220. In some embodiments, the vertical telescoping component 610 may be adjustable to selectively raise or lower the barbecue grill 600 to a desired height for the convenience of the user. Other embodiments are also possible.

In some embodiments, the telescoping assembly actuator 520 may be omitted, and the user may manually adjust the length of the telescoping arm 110 by disengaging a locking mechanism of the telescoping arm 110 and by pulling the barbecue grill using the handles, such as the handles 416 in FIG. 4. The locking mechanism of the telescoping arm 110 may include a plurality of holes disposed along the telescoping arm 110. In some examples, each segment of the telescoping arm may include two holes, allowing the telescoping arm 110 to be manually extended, one segment at a time, to a desired length. Further, the telescoping arm 110 may include an internal spring-loaded element configured to engage the holes to lock the telescoping arm 110 at a selected extension.

Additionally, in some embodiments, the barbecue grill 600 may include a universal serial bus (USB) interface 620, which may be coupled to the one or more batteries 518. In some embodiments, the USB interface 620 may be accessible via a door, a drawer, a cabinet or other feature that may be opened to allow access to the USB interface 620. In an example, the USB interface 620 may be coupled to a controller 624, which may be coupled to one or more speakers 626, control elements 512, and telescoping assembly actuator 520. A user may couple an external device 622 to the USB interface 620 to recharge or to access a music playlist, which may be performed by the controller 624 through the speakers 626. In some embodiments, the controller 624 may allow the external device 622 to control playback via the speakers 626.

Further, in some embodiments, the controller 624 may include a microcontroller unit, a field programmable gate array, a processor, or another data processing device capable of executing instructions stored in a memory (which may be a volatile or non-volatile memory, which may also be part of the controller 624). The controller 624 may be configured to control operation of the telescoping assembly actuator 520. In an example, the controller 624 can include an on-off switch that can be accessed to control operation of the telescoping assembly actuator 520. The controller 624 may also be coupled to the control elements 512 and may be configured to determine a state of one or more the control elements 512 and to control operation of one or more other components, such as the operation of valves 511. In a particular example, instructions that may be executed by the controller 624 may be received via the USB interface 620 (from external device 622). In some examples, the external device 622 may provide updated instructions to the controller 624 through the USB interface 620 to update the operation of the controller 624. Other embodiments are also possible.

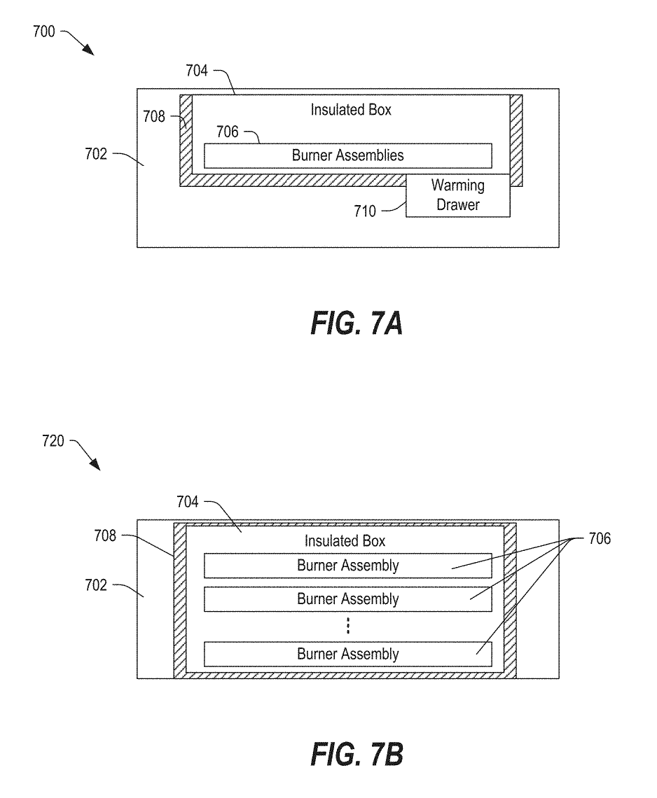

FIGS. 7A and 7B depict block diagrams of a portion of a barbecue grill including an insulated box, in accordance with certain embodiments of the present disclosure. In FIG. 7A, a barbecue grill 700 includes a housing 702 including a heated box 704 having one or more burner assemblies 706. The heated box 704 may be insulated by an insulative layer 708, which may surround the heated box 704 along the sides and the bottom. In some embodiments, a portion of the insulative layer may be omitted along a side or along the bottom adjacent to a warming drawer 710, which may be used to hold cooked food, keeping it warm until it is ready to be served.

In FIG. 7B, a top view 720 of the barbecue grill 700 of FIG. 7A is shown. Looking down into the heated box 704, it can be seen that the sides are insulated by the insulative layer 708. Further, the heated box 704 includes a plurality of burner assemblies 706, which extend along a length of the barbecue grill 106.

By arranging the burner assemblies 706 longitudinally, the number of controls and the number of valves for coupling the fuel source to the burner assemblies is reduced. In an example, each burner assembly may be divided into left and right burners, which may be separately controlled, allowing for different levels of heat being delivered to different areas of the cooking surface. Other embodiments are also possible.

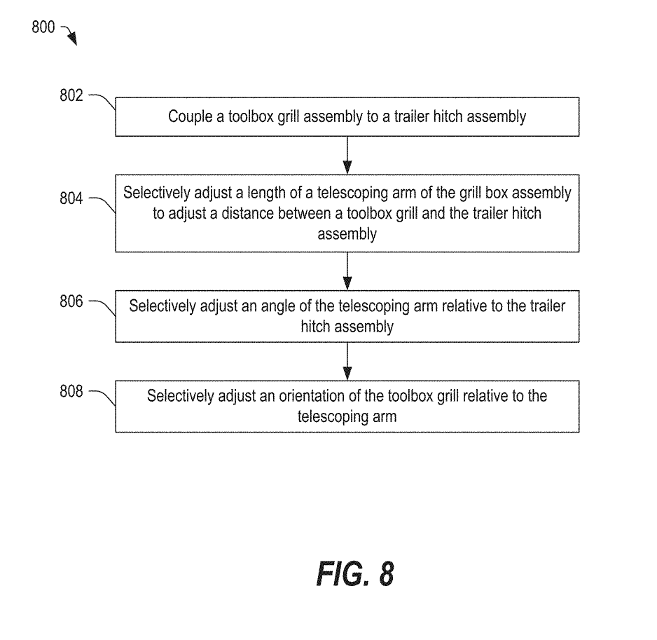

FIG. 8 depicts a flow diagram of a method 800 of selectively adjusting a relative position and orientation of a barbecue grill, in accordance with certain embodiments of the present disclosure. At 802, the method 800 may include coupling a toolbox grill assembly to a trailer hitch assembly. In some embodiments, the toolbox grill assembly may include a telescoping arm with a hitch attachment element configured to releasable couple to a trailer hitch.

At 804, the method 800 may include selectively adjusting a length of the telescoping arm of the grill box assembly to adjust a distance between the toolbox grill and the trailer hitch assembly. In some embodiments, the telescoping arm may be extended to space the toolbox grill from a rear of a vehicle, such as to allow space for the tailgate to be lowered. In some embodiments, in addition to adjusting the length of the telescoping arm, a vertical telescoping segment may be extended or retracted to adjust a height of the grill box assembly.

At 806, the method 800 may include selectively adjusting an angle of the telescoping arm relative to the trailer hitch assembly. In an example, the telescoping arm may pivot about a hinge element of the telescoping arm at a point between the trailer hitch and the toolbox grill.

At 808, the method 800 may include selectively adjusting an orientation of the toolbox grill relative to the telescoping arm. In some embodiments, the orientation may be adjusted by rotating the toolbox grill relative to the telescoping arm. In an example, the toolbox grill may be rotated via a bearing element between the toolbox grill and the telescoping arm.

In some embodiments, the toolbox grill may be operated without extending the telescoping arm and without pivoting the toolbox grill relative to the telescoping arm. Further, in some embodiments, the toolbox grill may be operated without adjusting the angle of the telescoping arm. In certain embodiments, the telescoping arm may be extended to allow a user to lower a tail gate or to otherwise provide space between the rear of a vehicle and the toolbox grill. In an example, the rear of the vehicle, the tail gate, or the trunk may then be used as a staging area from which the user may work.

In conjunction with the apparatus, system, components, and methods described above, a barbecue grill is disclosed that can be made to resemble a toolbox. In certain embodiments, the barbecue grill may include a telescoping arm including a coupling mechanism configured to couple to a trailer hitch assembly of a vehicle, a barbecue grill housing, and a bearing mechanism including a first portion coupled to the telescoping arm and including a second portion coupled to a bottom surface of the barbecue grill housing. The bearing mechanism may be configured to pivot the first portion relative to the second portion about a pivot axis that is substantially perpendicular to the bottom surface. In a further aspect, the telescoping arm may further include at least one section having a hinge configured to pivot about a second axis that is substantially parallel to the pivot axis of the bearing mechanism. In some embodiments, the barbecue grill may include a lid and optionally a drawer or cabinet for storage of barbecue equipment, which may be locked. In some embodiments, the barbecue grill may be disguised as a toolbox by forming the outer surface of the barbecue grill from sheet metal, such as stainless steel. In some embodiments, the sheet metal may be patterned, such as a diamond pattern sheet metal. Other embodiments are also possible.

Although the present invention has been described with reference to preferred embodiments, workers skilled in the art will recognize that changes may be made in form and detail without departing from the scope of the invention.

What is claimed is:

1. A barbecue grill assembly comprising:
a barbecue grill;
a telescoping arm including a coupling mechanism configured to couple to a trailer hitch assembly of a vehicle; and
a bearing mechanism including a first portion coupled to the telescoping arm and including a second portion coupled to a bottom surface of the barbecue grill, the bearing mechanism configured to pivot the barbecue grill relative to a pivot axis.

2. The barbecue grill assembly of claim 1, wherein the first portion of the bearing mechanism is configured to pivot about the pivot axis relative to the second portion.

3. The barbecue grill assembly of claim 2, wherein the pivot axis extends substantially vertically and perpendicular to the telescoping arm.

4. The barbecue grill assembly of claim 1, wherein the telescoping arm further includes at least one section having a hinge configured to pivot about a second axis that is substantially parallel to the pivot axis.

5. The barbecue grill assembly of claim 1, further comprising:
an actuator coupled to the telescoping arm; and
a controller coupled to the actuator and configured to control the actuator to selectively extend and retract the telescoping arm.

6. The barbecue grill assembly of claim 1, further comprising:
one or more cooking surfaces;
one or more burner assemblies; and
one or more control elements configured to control gas flow to the burner assemblies.

7. The barbecue grill assembly of claim 6, wherein the one or more control elements are positioned adjacent to and below a level of the one or more cooking surfaces.

8. The barbecue grill assembly of claim 1, further including a metallic housing configured to resemble a toolbox.

9. The barbecue grill of claim 8, wherein the metallic housing includes a sheet metal material along at least one side, the sheet metal material including a diamond pattern.

10. The barbecue grill of claim 1, wherein the telescoping arm is configured to extend a distance from the trailer hitch assembly that is sufficient to allow a tailgate of a pickup truck to be lowered when the barbecue grill is in use.

11. A barbecue grill assembly comprising:
a barbecue grill; and
a mounting assembly configured to couple the barbecue grill to a trailer hitch assembly of
a vehicle, the mounting assembly including:
a telescoping arm including a hinged section configured to pivot about a hinge axis extending perpendicular to a length of the telescoping arm;
a hitch element coupled to a first end of the telescoping arm and configured to releasably attach to a trailer hitch of a vehicle; and
a bearing element including a first portion coupled to the telescoping arm and including a second portion coupled to a bottom surface of the barbecue grill.

12. The barbecue grill assembly of claim 11, wherein the first portion of the bearing mechanism is configured to pivot relative to the second portion about a pivot axis.

13. The barbecue grill assembly of claim 12, wherein the pivot axis extends substantially vertically and perpendicular to the telescoping arm.

14. The barbecue grill assembly of claim 12, wherein the hinged section of the telescoping arm includes a hinge configured to pivot about the hinge axis that is substantially parallel to the pivot axis.

15. The barbecue grill assembly of claim 11, further comprising:
an actuator coupled to the telescoping arm; and
a controller coupled to the actuator and configured to control the actuator to selectively extend and retract the telescoping arm.

16. The barbecue grill assembly of claim 11, further comprising:
one or more cooking surfaces;
one or more burner assemblies; and
one or more control elements configured to control gas flow to the burner assemblies, the one or more control elements are positioned adjacent to and below a level of the one or more cooking surfaces.

17. The barbecue grill assembly of claim 11, further including a metallic housing configured to resemble a toolbox.

18. A barbecue grill assembly comprising:
a housing formed from a sheet metal material and configured to resemble a toolbox;
a mounting assembly including:
a bearing element including a first portion coupled to the housing and including a second portion, the first portion configured to pivot relative to the second portion about a pivot axis;
a hitch element configured to couple to a trailer hitch of a vehicle; and
a telescoping arm including a first end coupled to the second portion of the bearing element and including a second end coupled to the hitch element, the telescoping arm including at least one section including a hinge configured to pivot about a hinge axis parallel to the pivot axis; and
wherein the hinge axis and the pivot axis extend substantially vertically and perpendicular to a longitudinal axis of the telescoping arm.

19. The barbecue grill assembly of claim 18, further comprising:
one or more cooking surfaces;
one or more burner assemblies; and
one or more control elements configured to control gas flow to the burner assemblies, the one or more control elements positioned adjacent to and below a level of the one or more cooking surfaces.

20. The barbecue grill assembly of claim 18, further comprising:
an actuator coupled to the telescoping arm; and
a controller coupled to the actuator and configured to control the actuator to selectively extend and retract the telescoping arm.
